(19) United States
(12) Patent Application Publication
(10) Pub. No.: US 2012/0197550 A1
(43) Pub. Date: Aug. 2, 2012

(54) SYSTEM FOR DIAGNOSING ERROR CONDITIONS OF A GAS FLOW CONTROL SYSTEM FOR DIESEL ENGINES

(75) Inventors: Francesco CIANFLONE, Torino (IT); Gerhard LANDSMANN, Roedern (DE); Christopher ECK, Darmstadt (DE); Rolf ISERMANN, Darmstadt (DE); Andreas SIDOROW, Darmstadt (DE); Ulrich KONIGORSKI, Darmstadt (DE)

(73) Assignee: GM GLOBAL TECHNOLOGY OPERATIONS LLC, Detroit, MI (US)

(21) Appl. No.: 13/252,239

(22) Filed: Oct. 4, 2011

(30) Foreign Application Priority Data
Oct. 5, 2010 (GB) 1016727.8

(51) Int. Cl. G06F 19/00

(52) U.S. Cl. 702/45

(57) ABSTRACT

A combustion engine evaluation unit is provided that includes, but is not limited to a microcontroller receiving measurement signals from a gas flow control system and outputting a state signal of the gas flow control system. The microcontroller includes, but is not limited to input ports for receiving as first set of measurement signals. Furthermore, the microcontroller includes, but not limited to input ports for receiving as a second set of measurement signals. The microcontroller is configured to calculate a first set of predicted values with a gas flow model based on the first set of measurement signals and calculate a second set of predicted values with a nominal model based on the second set of measurement signals. The microcontroller is also configured to generate the state signal based on a comparison of the first set of predicted values with the second set of predicted values.

### CROSS-REFERENCE TO RELATED APPLICATION

This application claims priority to British Patent Application No. 1016727.8, filed Oct. 5, 2010, which is incorporated herein by reference in its entirety.

### TECHNICAL FIELD

The technical field is related to gas flow control and more particularly to a system for diagnosing error conditions of a gas flow control system for a diesel engine.

### BACKGROUND

Since the 1990s, the common rail system or storage injection system has been introduced for diesel engines of passenger cars. The use of a common rail injection is, however, not limited to passenger cars, but it also includes heavy duty diesel engines, for example ship engines. A common rail injection uses common high pressure storage with corresponding outlets to supply the cylinders with fuel. The common rail injection optimizes the combustion process and the engine run and reduces the emission of particles. Due to the very high pressure of up to 2000 bar, the fuel is atomized very finely. Since small fuel drops have a high surface area, the combustion process is accelerated and the particle size of emission particles is decreased. Moreover, the separation of the pressure generation and the injection process allows for an injection process that is electronically controlled by using characteristic maps in a control unit, such as an engine control unit (ECU). The ECU may also be used to monitor the functionality of air handling control mechanisms for faults or failures that may occur during operation thereof. Error detection has been made mandatory in US and EU on-board diagnosis requirements.

The common rail injection system may be combined with a turbocharger to provide more driving comfort, especially for diesel engines in passenger cars. However, when combustion occurs in an environment with excess oxygen, peak combustion temperatures increase which leads to the formation of unwanted emissions, such as oxides of nitrogen (NOx). These emissions increase when a turbocharger is used to increase the mass of fresh air flow, and hence increase the concentrations of oxygen and nitrogen in the combustion chamber when temperatures are high during or after the combustion event.

One known technique for reducing unwanted emissions like NOx involves introducing chemically inert gases into the fresh air flow stream for subsequent combustion. Thereby, the oxygen concentration in the combustion mixture is reduced, the fuel burns slower and peak combustion temperatures are accordingly reduced and the production of NOx is reduced. One way of introducing chemically inert gases is through the use of a so-called Exhaust Gas Recirculation (EGR) system. EGR operation is typically not required under all engine operating conditions, and known EGR systems accordingly include a valve, commonly referred to as an EGR valve, for controlled introduction of exhaust gas to the intake manifold. Through the use of an on-board microcontroller, control of the EGR valve is typically accomplished as a function of information supplied by a number of engine operational sensors. To achieve exhaust gas recycling, high pressure and low pressure EGR systems are used alone or in combination.

In addition to an EGR valve, air handling systems for modern turbocharged internal combustion engines are known to include one or more supplemental or alternate air handling control mechanisms for modifying the swallowing capacity and/or efficiency of the turbocharger. For example, the air handling system may include a waste gate disposed between an inlet and outlet of the turbocharger turbine to selectively route exhaust gas around the turbine and thereby control the swallowing capacity of the turbocharger. Alternatively or additionally, the system may comprise an exhaust throttle disposed in line with the exhaust conduit either upstream or downstream of the turbocharger turbine to control the effective flow area of the exhaust is throttle and thereby the efficiency of the turbocharger.

The turbocharger may also comprise a variable geometry turbine, which is used to control the swallowing capacity of the turbocharger by controlling the geometry of the turbine. By using a variable nozzle ring geometry, the turbocharger operating envelope and performance can be changed during operation to optimize the engine performance for certain conditions. This type of turbochargers is useful e.g. in lean burn gas engines, where combustion is sensitive to gas quality and air temperature variations. VTG technology can also be used for heavy diesel engines, such as train and ship engines. However, the operating conditions of a turbocharger on a heavy fuel engine are rather demanding and VTG technology is, at least today, not commonly used for heavy fuel engines.

It is at least one object to provide an improved fault diagnostic for a gas flow control system of a turbocharged engine for a passenger car, especially of a common rail turbo diesel engine. In addition, other objects, desirable features and characteristics will become apparent from the subsequent summary and detailed description, and the appended claims, taken in conjunction with the accompanying drawings and this background.

### SUMMARY

A combustion engine evaluation unit is provided that comprises a microcontroller for receiving measurement signals from a gas flow control system of a combustion engine and for outputting a state signal indicating a state of the gas flow control system. The microcontroller comprising input ports for receiving a first set of measurement signals that comprises at least an intake pressure downstream of a high pressure exhaust gas recirculation valve, an intake temperature downstream of a high pressure exhaust gas recirculation valve and an intake air flow rate downstream of an air filter. Furthermore, the microcontroller also comprises input ports for receiving for second set of measurement signals which comprises at least a motor revolution speed and a flap valve position signal. The flap valve position signal may be provided by a flap valve control signal or also by a position sensor at the flap valve. Flap valves are useful for controlling the motion of intake gas into cylinders of the engine. It is advantageous to observe the air mass flow to detect leakages and/or constrictions in the air flow path. In order to accurately determine the gas flow rates, it is advantageous to use the position of flap valves according to the application as an input for a fault detection system which is based on computations of air mass flows according to the application. The microcontroller is furthermore adapted to calculate a first set of predicted values by using a gas flow model, based on the first set of measurement signals and to calculate a second set of predicted values by using a nominal model, based on the second set of measurement signals.

The comparison of the first set of predicted values with the second set of predicted values may be provided by at least one differentiator which is technically easy to realize. Advantageously, one differentiator is provided for each predicted value of the nominal model. More specifically, a residual generation unit with differentiators is provided for the comparison of the first set of predicted values and the second set of predicted values and the differentiators are adapted to generate residuals by subtracting values of the second set of predicted values from corresponding values of the second set of predicted values with the differentiators. The use of differentiators instead of more complicated units is an advantage of the present application. However, the comparison of predicted values may also be provided by at least one correlator that provides a statistical correlation.

The nominal model may be provided by a nominal model unit which comprises an interpolation unit. More specifically, the interpolation unit may be provided by a realization of a semi-physical model, a neuronal network, a local linear model tree model, abbreviated as LOLIMOT or as LLM, or another empirical model. Specifically, the interpolations may be based on values of a look up table which is pre-computed based on the aforementioned models during a calibration procedure.

The microcontroller is furthermore adapted to generate the state signal based on a comparison of the first set of predicted values with the second set of predicted values. The state signal indicates whether an error condition is present and may take on “yes/no” values or even probabilities.

A gas flow control system provides a reliable identification of faulty components. The indication of faulty parts according to the application helps to avoid pollution and safety hazards that result from driving with faulty components and extends the lifetime of mechanical parts through timely exchange of the faulty components. Furthermore, a gas flow control system according to the application assists the service personnel in quickly identifying the cause of a malfunction. Apart from identifying error conditions, the gas flow control system can also be used to adjust the engine control, such as the control of the fuel injection or of the valve openings, in order to maintain the function even in the case of degrading performance of mechanical parts.

According to an embodiment, the residual generation unit is adapted to generate an air efficiency residual from the first set of measurement signals and the second set of measurement signals. In a more specific realization, the air efficiency residual is based on a difference of a first predicted air efficiency from the first set of predicted values and a second predicted air efficiency from the second set of predicted values and the second predicted air efficiency is based on a lookup table value that depends on the engine speed, the intake pressure and the flap valve control or, respectively, position signal.

According to another embodiment, the residual generation unit is adapted to generate an air flow oscillation amplitude residual form the first set of measurement signals and the second set of measurement signals. In a more specific realization, the second set of measurement values comprises an EGR valve position and the air flow oscillation amplitude residual is based on a difference of a first predicted air flow oscillation amplitude from the first set of predicted values and a second predicted air flow oscillation amplitude from the second set of predicted values. Moreover, the second predicted air flow oscillation amplitude is based on a lookup table value that depends on the engine speed, the intake pressure, the intake temperature and the EGR valve position. The EGR valve position may correspond to high pressure or low pressure EGR valves and the position may be derived from an actuator command signal or also by a position sensor signal.

According to another embodiment, the residual generation unit is adapted to generate a pressure oscillation amplitude residual from the first set of measurement signals and the second set of measurement signals. In a more specific realization, the second set of measurement values comprises an EGR valve position and the pressure oscillation amplitude residual is based on a difference of a first predicted pressure oscillation amplitude from the first set of predicted values and a second predicted pressure oscillation amplitude from the second set of predicted values. Furthermore, the second predicted pressure oscillation amplitude is based on a lookup table value that depends on the engine speed, the intake pressure, the intake temperature and the EGR valve position.

According to another embodiment, the first set of measurement signals further comprises an exhaust pressure upstream of an EGR valve and an EGR valve temperature and wherein the residual generation unit is adapted to generate at least one gas flow residual from the first set of measurement signals and the second set of measurement signals. In a more specific realization, the at least one gas flow residual is based on a difference of a first predicted mass flow from the first set of predicted values and a second predicted mass flow from the second set of predicted values. Furthermore, the second predicted mass flow is based on a lookup table value that depends on the engine speed, the pressure downstream of the EGR recirculation valve and the command signal of the flap valve.

According to another embodiment, the at least one gas flow residual is based on a difference of a first predicted mass flow from the first set of predicted values and a second predicted mass flow from the second set of predicted values. The second predicted mass flow is based on the engine speed, a measurement value from a lambda or an oxygen sensor and a volume of injected fuel. For an evaluation of the residuals, a dead zone unit may be provided for setting the residual to zero if the residual lies between a lower limit and an upper limit. Advantageously the lower limit and the upper limit are based on an operating point, such as the motor revolution speed, an EGR position signal, a flap valve position signal. Especially, the operating point may depend on an engine speed and a fuel flow rate.

Furthermore, an engine control unit is provided that comprises the aforementioned combustion engine evaluation unit wherein input ports of the engine control unit are connected to the input ports of the combustion engine evaluation unit and output ports of the engine control unit are connected to output ports of the combustion engine evaluation unit. Moreover, the application discloses also a combustion engine that comprises a turbocharger and gas flow control system and the aforementioned engine control unit, wherein sensor outputs and actuator inputs of the gas flow control system are connected to the engine control unit.

A powertrain is provided with the aforementioned combustion engine. A crank-shaft of the combustion engine is connected to an input shaft of the powertrain and a vehicle with the aforementioned powertrain. The powertrain is connected to a wheel of the vehicle.

### BRIEF DESCRIPTION OF THE DRAWINGS

The present invention will hereinafter be described in conjunction with the following drawing figures, wherein like numerals denote like elements, and:

FIG. 1 shows a diagrammatic illustration of a gas flow control system for a turbo diesel engine;

FIG. 2 illustrates error conditions of the gas flow control systems;

FIG. 3 illustrates a residual generating unit for a HP-EGR cycle;

FIG. 4 illustrates a residual generating unit for a LP-EGR cycle;

FIG. 5 illustrates a decision logic and an error display for evaluating the residuals;

FIG. 6 illustrates a neural network of a decision logic;

FIG. 7 illustrates diagrams of motor speeds and motor torque for various operating points;

FIG. 8 illustrates a diagram of a nominal model for a turbocharger shaft speed;

FIG. 9 illustrates a flow diagram of a residual evaluation;

FIG. 10 shows a partitioning of a parameter space;

FIG. 11 illustrates a definition procedure for lower and upper thresholds of residuals;

FIG. 12 illustrates in further detail a residual evaluation according to FIG. 9; and

FIG. 13 shows a detailed view of a residual generation unit.

### DETAILED DESCRIPTION

The following detailed description is merely exemplary in nature and is not intended to limit application and uses. Furthermore, there is no intention to be bound by any theory presented in the preceding background or summary or the following detailed description.

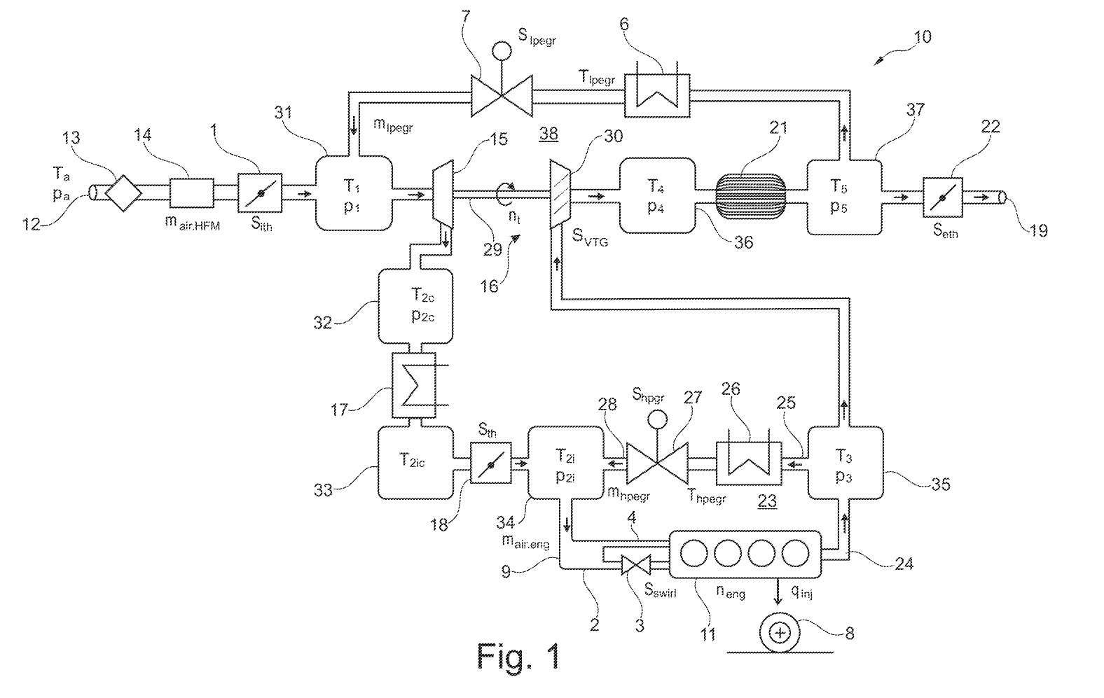

FIG. 1 shows a diagrammatic illustration of a gas flow control system 10 for a turbo diesel engine 11. A crankshaft of the diesel engine 11 is connected a drivetrain which is connected to wheels 8 of a car. For simplicity, crankshaft and drivetrain are not shown in FIG. 1. Between an air intake 12 and an air inlet 9 of the diesel engine 11, the gas flow control system 10 comprises an air filter 13, a hot film (HFM) air mass flow sensor 14, an intake throttle 1, and a compressor 15 of a turbocharger 16, an intake air cooler 17 and an intake air throttle 18. Between the diesel engine 11 and an exhaust outlet 19, the gas flow control system 10 comprises an exhaust turbine 20 of the turbocharger 16, a diesel particulate filter (DPF) 21 with a diesel oxidation catalyst (DOC) and an exhaust throttle 22.

The gas flow control system 10 comprises a high pressure exhaust gas recirculation (HP EGR) circuit 23. Between an exhaust outlet 24 of the diesel engine 11 and the air intake 9 of the diesel engine 11, the HP-EGR circuit 23 comprises a bypass branch 25, a HP-EGR cooler 26, a HP-EGR valve 27 and a recirculation branch 28. Furthermore, a low pressure exhaust gas recirculation (LP-EGR) circuit 38 is provided between the DPF 21 and the compressor 15. The LP-EGR circuit 38 comprises an LP-EGR cooler 6 and an LP-EGR valve 7 downstream of the LP-EGR cooler 6.

Downstream of the intake air cooler 17 and the intake air throttle 18, the intake manifold branches off to the cylinders of the engine 11. The cylinders comprise a first inlet channel 2 with a swirl flap valve 3 and a second inlet channel 3. For simplicity, only one set of inlet channels 2, 3 is shown. In an alternative embodiment the inlet channel 2 is connected to the recirculation branch 28 and the inlet channel 4 is connected to the intake throttle 18. In this case, mixing in of exhaust gas occurs in the combustion chamber of the cylinder. The swirl flap valves 3 are connected to an actuator which is connected to a command line of the ECU 89.

For simplicity, pipes from and to the cylinders of the diesel engine 11 are not indicated separately. Likewise, fuel lines are not shown. The exhaust turbine 20 and the compressor 15 are linked by a compressor shaft 29 and the rotation velocity n_tc of the compressor shaft 29 is indicated by a circular arrow. The exhaust turbine has a variable geometry which is controlled by a control signal sVTG. The variable geometry of the exhaust turbine 20 is realized by adjustable turbine blades 30 which are indicated by slanted lines. Mass flow rates of the HP-EGR cycle 23 and the LP-EGR cycle are indicated by corresponding symbols and the ambient input temperature and pressure upstream of the air filter 13 are indicated by symbols T_a and p_a.

Various locations of sensors in the gas flow are indicated by square symbols. The square symbol is only symbolic and does not indicate the precise shape of a gas pipe at the location of a sensor. A first sensor location 31 and corresponding temperature T_1 and pressure p_1 are indicated between the HFM air mass flow sensor 14 and the compressor 15; a second sensor location 32 and corresponding temperature T_2c and pressure p_2c are indicated between the compressor 15 and the intake air cooler 17; a third sensor location 33 and corresponding temperature T_2ic is indicated between the intake air cooler 17 and the intake air throttle 18; a fourth sensor location 34 and corresponding temperature T 21 and pressure p_2i are indicated between the intake air throttle 18 and the inlet 9 of the diesel engine 11 or, respectively, the HP-EGR valve 27; a fifth sensor location 35 and corresponding temperature T_3 and pressure p_3 are indicated between the outlet 24 of the diesel engine 11 and the HP-EGR cooler 26 or, respectively, the exhaust turbine 20; a sixth sensor location 36 and corresponding temperature T_4 and pressure p_4 are indicated between the exhaust turbine 20 and the DPF 21; a seventh sensor location 37 with corresponding temperature T_5 and pressure p_5 is indicated between the DPF 21 and the exhaust gas throttle 22. Downstream of the exhaust throttle 22 there are an H₂S catalyst and an exhaust silencer which are not shown in FIG. 1. The gas flow control system 10 may be realized with our without the low pressure EGR cycle 38. Moreover, the HP-EGR cycle 23 may be provided separately for cylinders or groups of cylinders. A NOₓ storage catalyst (NSC) may be provided upstream of the exhaust throttle 22.

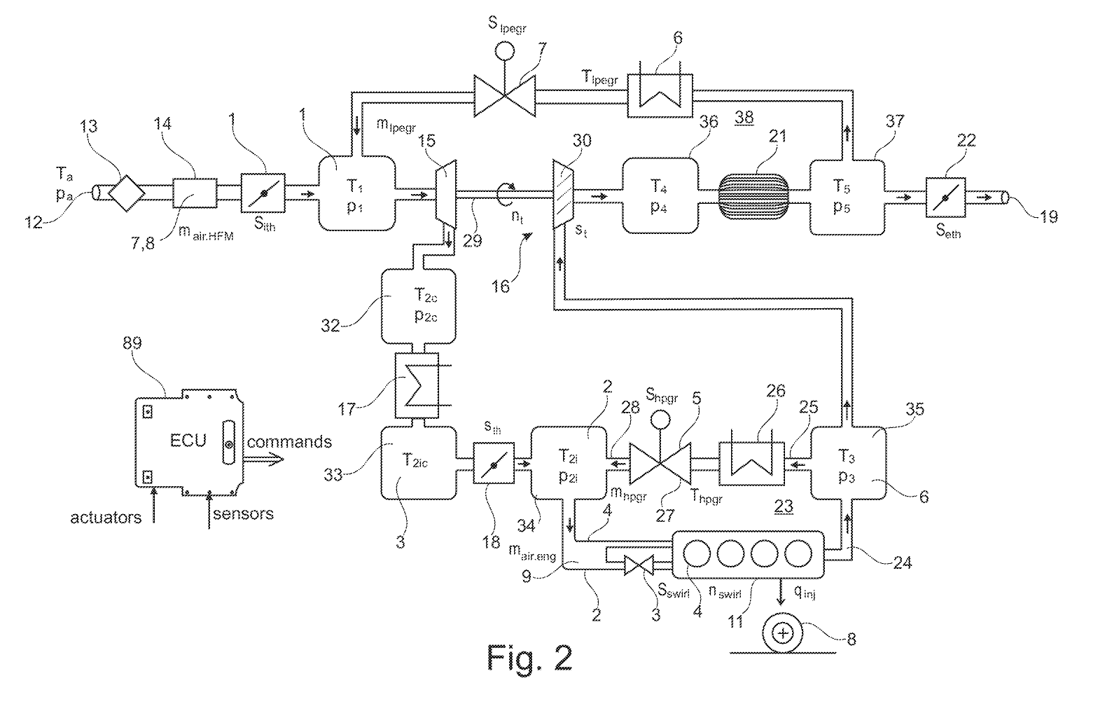

FIG. 2 shows in more detail 8 error conditions that occur in a turbo diesel engine with EGR according to the application. An ECU unit 89 is shown, which is provided for evaluating the residuals and which receives sensor and actuator signals and which outputs command signals. In FIG. 18, the error conditions are labeled by circled numbers.

A blow-by error condition (1), which is determined based on measurements at measurement location 31, is given when the blow-by tube of the engine 11 has a leakage or is missing. The blow-by tube is not shown in FIG. 2. It serves to let exhaust gases escape from the crankcase which have entered the crankcase by malfunction and/or by leaky cylinders. The exhaust gases may be blown out or recycled. The blow-by error condition leads to a leakage mass flow rate indicated by the time derivative d/dt(m_leak(t)). An intercooler leakage error condition (2), which is determined based on measurements at measurement location 34, is given by a leakage after the intercooler 17 between the compressor 15 and the turbocharger 18. The corresponding leakage mass flow rate is indicated by d/dt(m_leak). An intercooler restriction error condition (3) that occurs when there is a restriction downstream of the intercooler 17 is determined based on measurements at the measurement location 33.

A swirl flap position error condition (4) is determined based on measurements at the measurement location 34. The swirl flaps or flap valves, which are not shown in FIGS. 1 and 2, are positioned at inlet channels of the cylinders and are actuated by a common actuator which receives a flap valve command signal from the ECU. The swirl flaps are used to mix the exhaust gas of the HP-EGR cycle 23 into the combustion gas of a cylinder. In the simplified FIGS. 1 and 2, the position of the swirl flap is at the recirculation branch 28.

An EGR position error condition (5) is indicated at the HP-EGR valve 27. It may be determined by direct position measurement at the HP-EGR valve 27 or based on measurements at measurement locations 35 and 34. An exhaust leakage error condition (6) is determined based on measurements at measurement location 35. The corresponding leakage mass flow rate is indicated by d/dt(m_leak). An HFM high (7) and an HFM low (8) error condition is indicated at the hot film airflow meter 14. They correspond to airflow measurements which are too high or too low, respectively.

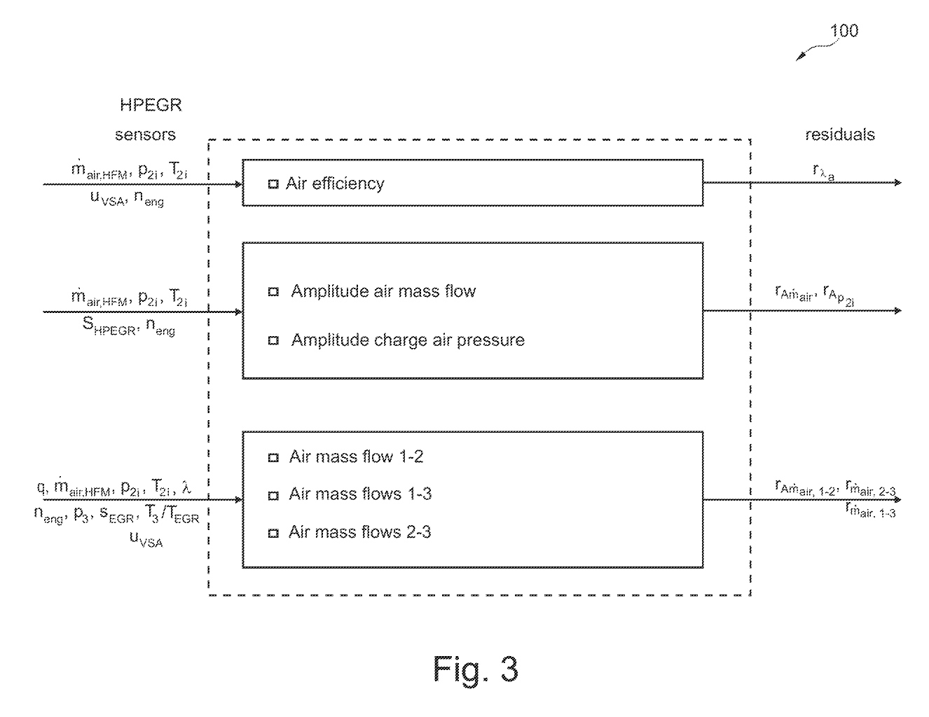

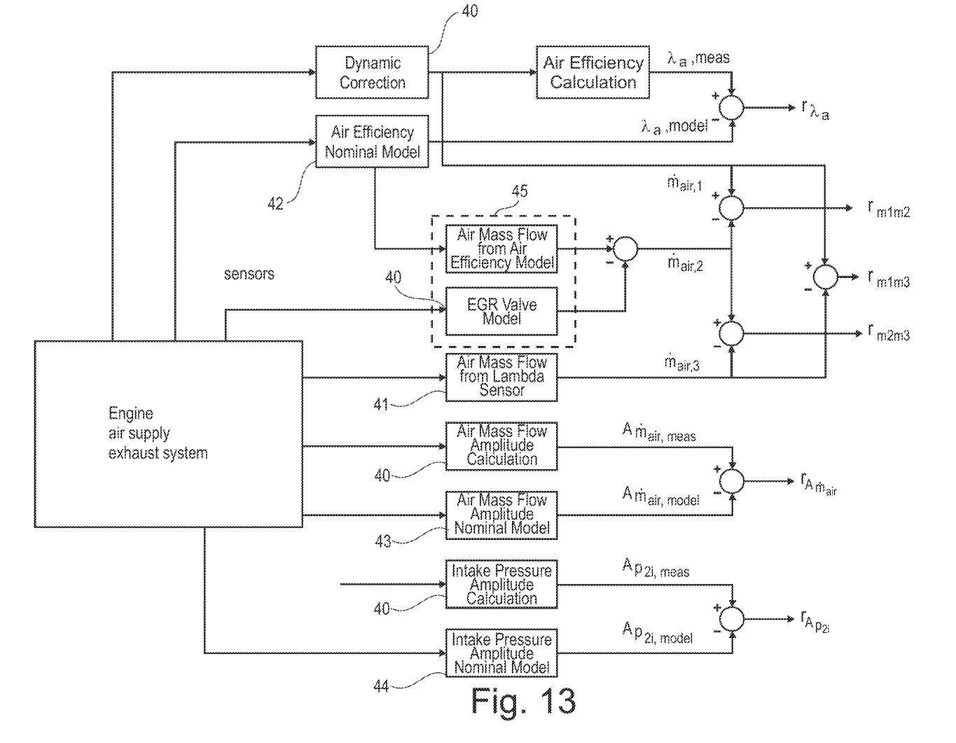

FIG. 3 shows a residual generation unit 100 for generating residuals for a high pressure EGR operation. The left side shows input values from a first and a second set of measurement values which are used as input values for submodel units. The submodel units each comprise a nominal or semi physical model unit and a physical model unit. The nominal model units are indicated in FIG. 13. The input values are explained below. T_3/T_EGR means that the temperature values T_3 and T_EGR may be used alternatively or in combination, for example in order to spare a sensor at the EGR valve 27 and use a sensor at measurement location 35 instead or in order to use two values instead of one to have fault tolerance through redundancy.

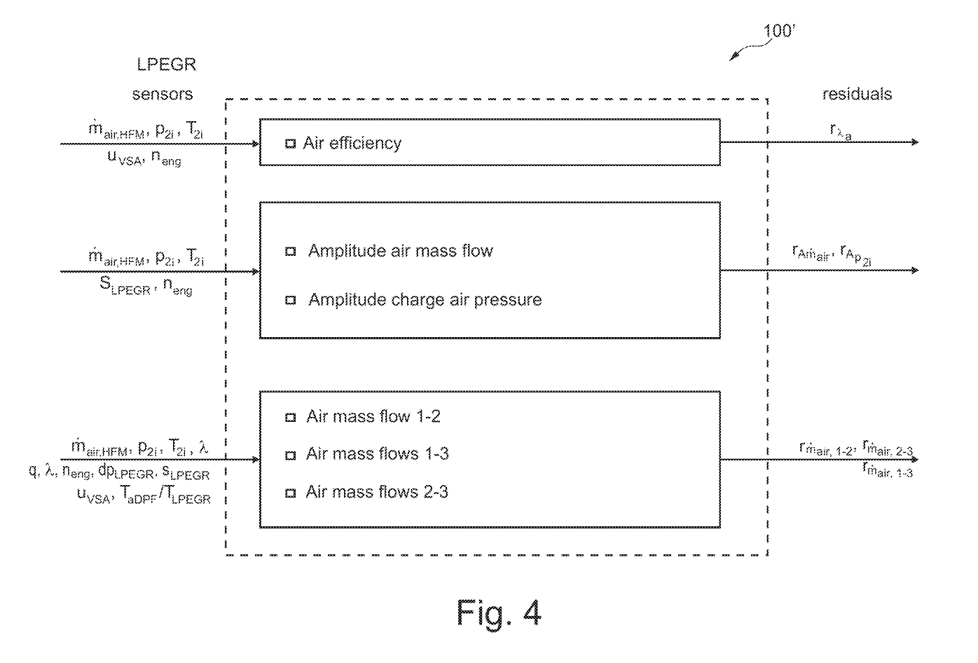

FIG. 4 shows a residual generation unit 100′ which is essentially identical to the residual generation unit 100 but instead of the input values p_3, s_EGR, T_3/TEGR of the HP-EGR cycle 23 it uses measurement values of the LP-EGR cycle 38, wherein dp_LEGR is a pressure difference across the LP EGR valve, s_LEPGR is a LP-EGR valve control signal, T_aDPF is a temperature downstream of the DPF 21 and upstream of the LP-EGR cooler, T_LPEGR is a temperature downstream of the LP-EGR cooler 6 and upstream of the LP-EGR valve 7. Again, T_aDPF can be used instead of or in combination with T_LPEGR. The low pressure EGR cycle 38 may be used in addition to the HP-EGR cycle 23.

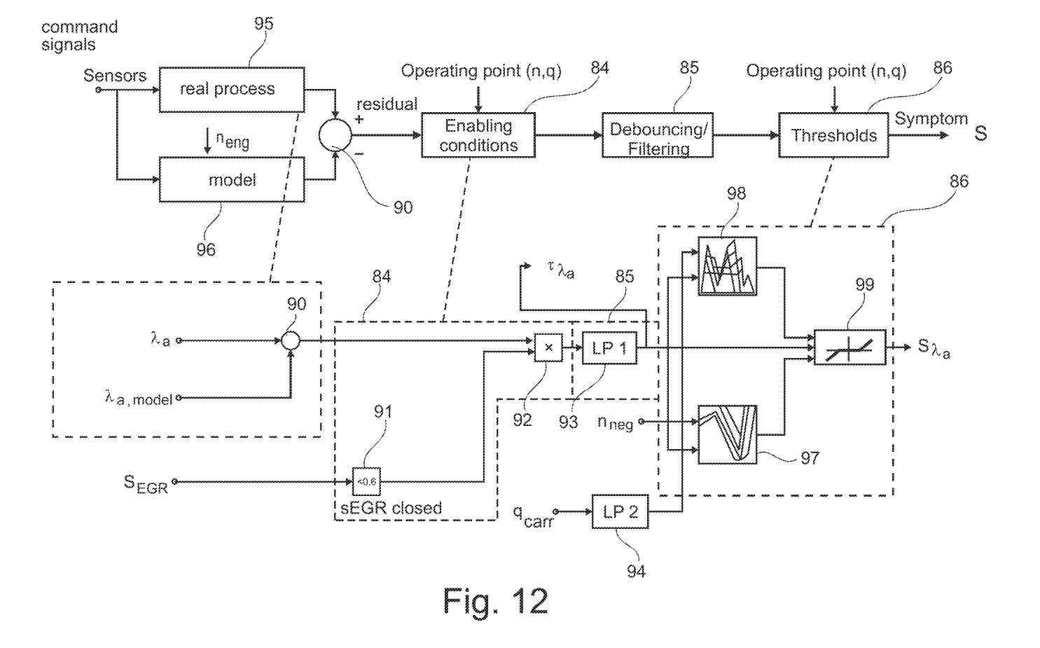

Preferentially, the flow diagram of FIG. 3 applies to a high pressure operation mode in which the HP-EGR valve is open and the LP-EGR valve is closed and the FIG. 4 applies to a low pressure operation mode in which the HP-EGR valve is closed and the LP-EGR valve is open. The operation of the residual generation units 100, 100′ is now explained in more detail. The residual for the air flow efficiency also known as volumetric efficiency, is calculated according to

$${r}_{{λ}_{a}} = \frac{{\dot{m}}_{air , HFM} - \frac{d {p}_{2 i}}{d t} \cdot \frac{{v}_{sub}}{{RT}_{2 i}}}{0.5 \cdot {n}_{eng} \cdot {V}_{d} \cdot \frac{{p}_{2 i}}{{RT}_{2 i}}} - {LLM}_{{λ}_{a}} ( {n}_{eng} , {p}_{2 i} , {u}_{VSA} )$$

Where u_vsa is the command signal of the VSA valve, d/dt(m_air_HFM) is the measured mass flow at the hot film meter 14 V_sub is the total volume between the HFM air flow meter 14 and a p_2i pressure meter at the measurement location 34, V_d is the displacement volume of all cylinders, V_d=n_cylinders *V_cylinder, R is the ideal gas constant and LLM is an LLM-model. The left term corresponds to λ_a and the right term corresponds to λ_a,model of FIG. 12. Instead of u_vsa, a position signal from a flap valve actuator may be used.

The residuals for the mass flow and p_2 amplitudes are computed according to

r_{A}_{_{\dot{m}}}=A_{\dot{m}}_{ₐᵢᵣ}−Grid_{A}_{_{\dot{m}}}(n_{eng},ρ₂ᵢ,s_{EGR})

r_{A}_{ₚ₂}=Aₚ₂−Grid_{A}_{ₚ₂}(n_{eng},ρ₂ᵢ,s_{EGR})

Where s_EGR denotes the respective signal s_LPEGR or s_HPEGR. Alternatively, the nominal amplitudes may also be computed from the engine revolution speed n_eng and the intake density ρ²¹ alone by a grid model an LLM model or the like,

A_{\dot{m}}_{ₐᵢᵣ}_{,no min al}=Grid_{A\dot{m}}(n_{eng},ρ₂ᵢ)

A_{p2,no min al}=Grid_{Ap2}(n_{eng},ρ₂ᵢ)

The air mass flow and the boost pressure p_2 oscillate with the period of the opening and closing of the intake valves. The amplitudes A refer to the magnitudes of these oscillations. It is also possible to measure the amplitudes in the exhaust path instead of in the intake path. The oscillations can be approximated by

$${\dot{m}}_{air , HFM} ( {α}_{CA} ) = {\overline{\dot{m}}}_{air , HFM} + {A}_{{\dot{m}}_{air , HFM}} \cdot cos ( 2 π \cdot \frac{{α}_{CA}}{180 ° CA} - {φ}_{{\dot{m}}_{air ,} HFM} )$$

$$and$$

$${p}_{2 i} ( {α}_{CA} ) = {\overline{p}}_{2 i} + {A}_{{p}_{2 i} , measured} \cdot cos ( 2 π \cdot \frac{{α}_{CA}}{180 ° CA} - {φ}_{{p}_{2 i}} ) .$$

For a four cylinder four stroke engine, an oscillation with a period of 180° CA (crankshaft angle) results. In general, the oscillation period amounts to (720° CA*n_cylinders)/k_combustion, where k_combustion=2 for a 4-stroke and 1 for a 2 stroke combustion

“Grid” refers to model values which are dependent on an operating point which is defined by the engine revolution speed n_eng, the boost density ρ_2i at measurement location 34 and the position s_EGR of an EGR valve. Herein, s_EGR refers to the HP-EGR valve for the model of FIG. 3 and to the LP-EGR valve for the model of FIG. 4. The model values may be derived from a grid model but also from a neuronal net or from a local linear modeling tree model. Furthermore, the model values may be predetermined and stored in a lookup table and interpolation may be used to derive model values at intermediate grid points.

The left terms are derived from sensor values of the air flow rate and the pressure p_2 and correspond to the physical model. Herein, the left terms correspond to the physical model and the right terms to the nominal model. The boost density may ρ_2i may be computed based on the input values p_2i, T_2i shown in FIGS. 3, 4 using the ideal gas equation according to ρ_2i=(p_2i*MW)/(R*T_2i), wherein MW is a mean molecular weight of the gas mixture and R is the ideal gas constant.

The air mass flow rates are computed according to

$${\dot{m}}_{air , eng , 1} = {\dot{m}}_{air , HFM} - \frac{d {p}_{2 i}}{d t} \cdot \frac{{V}_{E}}{{RT}_{2 i}}$$

$${\dot{m}}_{air , eng , 2} = 0.5 \cdot {LLM}_{{λ}_{a}} ( {n}_{eng} , {p}_{2 i} , {u}_{VSA} ) \cdot {n}_{eng} \cdot {V}_{d} \cdot \frac{{p}_{2 i}}{{RT}_{2 i}} - \frac{{\dot{m}}_{EGR} {T}_{EGR}}{{T}_{2 i}}$$

$${\dot{m}}_{air , eng , 3} = λ \cdot {\dot{m}}_{f} \cdot 14.5 {\dot{m}}_{f} = 2 \cdot q \cdot {n}_{eng} \cdot {ρ}_{Diesel} ,$$

respectively, where V_E is an intake volume which is equivalent to the above-mentioned volume V_sub, λ denotes a measurement value from an oxygen or lambda sensor before or after the turbine, d/dt(m_f) is the fuel mass flow, q is the volume of injected fuel in cubic millimeters per cycle.

Herein, the left term of the second equation and the right side of the equation for d/dt(m_air,eng,3) can be regarded as outputs of nominal model units. The numerical value 0.5 applies to 4-stroke combustion. In general, the value 1/k_combustion must be used. The numerical value 14.5 represents a stoichiometric air to fuel ratio for diesel fuel.

T_EGR relates to a temperature which is measured by a temperature sensor which is close to the HP-EGR or the LP-EGR valve, respectively. Preferably, the temperature sensor is placed upstream of the EGR-valve between the respective EGR valve 27 or 7 and the corresponding intercooler 26 or 6. The EGR mass flow d/dt(m_EGR) can be modeled, for example, by taking into account a pressure difference Δp_EGR between a pressure upstream of the valve and a pressure downstream of the EGR-valve and an EGR-valve opening s_EGR which may be derived from a control signal or a position sensor. In a simple model, the EGR mass flow is proportional to both Δp_EGR and s_EGR. In a more accurate model, a temperature upstream of the respective EGR valve is used to take into account the gas density,

$${\dot{m}}_{EGR} = \frac{d}{d t} ( Δ {p}_{EGR} ) \times \frac{{V}_{EGR} ( {s}_{EGR} )}{{RT}_{EGR}} ,$$

Where V_EGR is a characteristic volume that depends on the valve opening signal s_EGR. In a more accurate model, the mass flow rates through the low pressure and the high pressure EGR valves are calculated according to

$${\dot{m}}_{hpegr} = μ {A}_{eff , hpegr} \frac{{p}_{3}}{\sqrt{{RT}_{hpegr}}} \sqrt{\frac{2 {κ}_{e}}{{κ}_{e} - 1} [ {( \frac{{p}_{2 i}}{{p}_{3}} )}^{\frac{2}{{κ}_{e}}} - {( \frac{{p}_{2 i}}{{p}_{3}} )}^{\frac{{κ}_{e} + 1}{{κ}_{e}}} ]}$$

$$and$$

$${\dot{m}}_{lpegr} = μ {A}_{eff , lpegr} \frac{{p}_{5}}{\sqrt{{RT}_{lpegr}}} \sqrt{\frac{2 {κ}_{e}}{{κ}_{e} - 1} [ {( \frac{{p}_{1}}{{p}_{5}} )}^{\frac{2}{{κ}_{e}}} - {( \frac{{p}_{1}}{{p}_{5}} )}^{\frac{{κ}_{e} + 1}{{κ}_{e}}} ]} ,$$

Where μA_{eff,hpegr}=f_{hpegr}(s_{hpegr}) and μA_{eff,lpegr}=f_{lpegr}(s_{lpegr}). Herein, f_egr is an approximation function, for example a polynomial and κ_e is an adiabatic exponent of the exhaust gas. P_2i and p_3 and, respectively, p_1 and p_5 correspond to pressures downstream and upstream of the respective EGR valve, especially to pressures at the indicated measurement locations.

From the abovementioned relationships, the corresponding residuals are computed as:

r_{\dot{m}}_{ₐᵢᵣ}_{,1-2}=\dot{m}_{air,1}−\dot{m}_{air,2}

r_{\dot{m}}_{ₐᵢᵣ}_{,1-3}=\dot{m}_{air,1}−\dot{m}_{air,3}

r_{\dot{m}}_{ₐᵢᵣ}_{,2-3}=\dot{m}_{air,2}−\dot{m}_{air,3}

These differences can be represented as differences between terms of a physical model unit and terms of a nominal model unit, wherein the outputs of the physical model units are defined by those terms that are not outputs of the nominal model units.

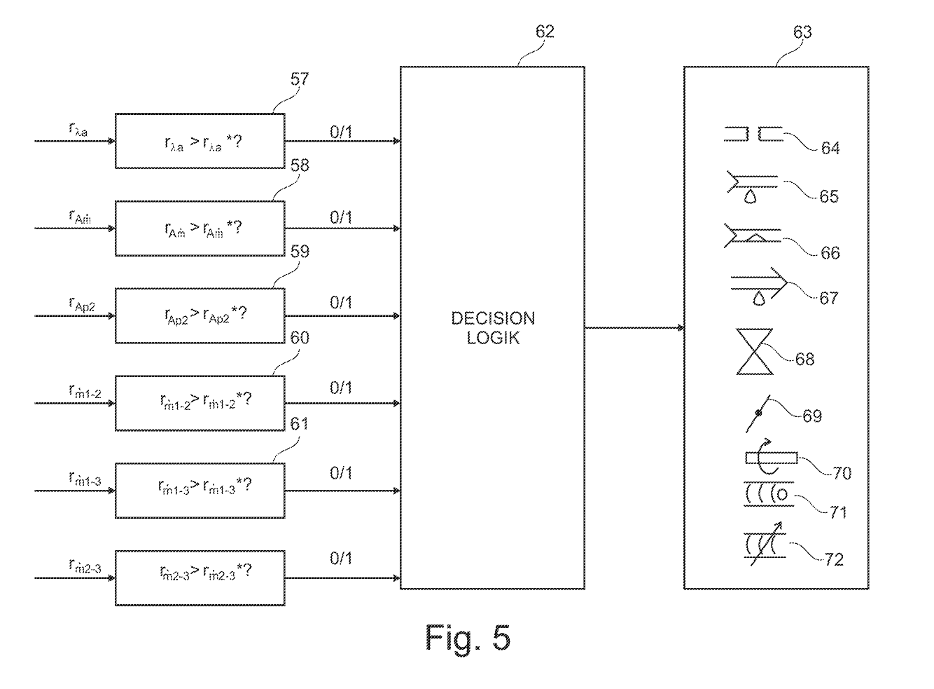

FIG. 5 shows an embodiment of an evaluation unit in which the evaluation unit comprises comparators 57, 58, 59, 60, 61 and a decision logic circuit 62. Outputs of the comparators are connected to inputs of the decision logic circuit 62. An output of the decision logic circuit 62 is connectable to a control display 63. The control display 63 provides display symbols 64, 65, 66, 67, 68, 69, 70, 71, 72 to indicate the error conditions of a blow-by pipe failure, an intake manifold leakage, an intake manifold blockage, an exhaust manifold leakage, an EGR-valve failure, a swirl flap failure respectively.

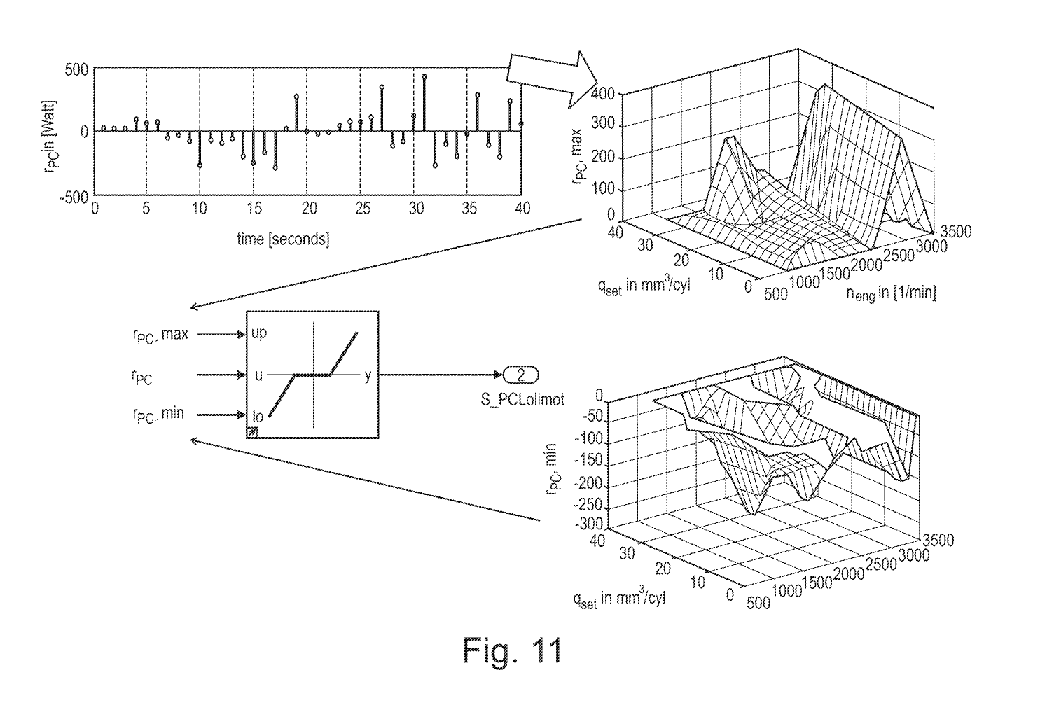

During operation, the comparators compare the absolute value of the residuals r_λa, r_A_m_air, r_A_p_2i, r_m_air_1-2, r_m_air_2-3, r_m_air_1-3 against corresponding limit values and generate binary output signals. Alternatively, comparators are provided to compare the value of the residuals, which may be positive as well as negative, against respective negative and positive limiting values. Furthermore, the limit values may depend on an operating point. This is shown in more detail in FIG. 11.

The binary output signals are evaluated by the decision logic circuit 62 and an error condition signal is generated. The error condition signal may indicate a single error condition or also a combination of error conditions. In a particularly simple embodiment, the logic circuit 62 comprises a lookup table for mapping the binary outputs of the comparators 57, 58, 59, 60, 61 to an error condition value that indicates an error condition or a combination of error conditions. On the control display 63, display symbols are displayed which correspond to the error condition value.

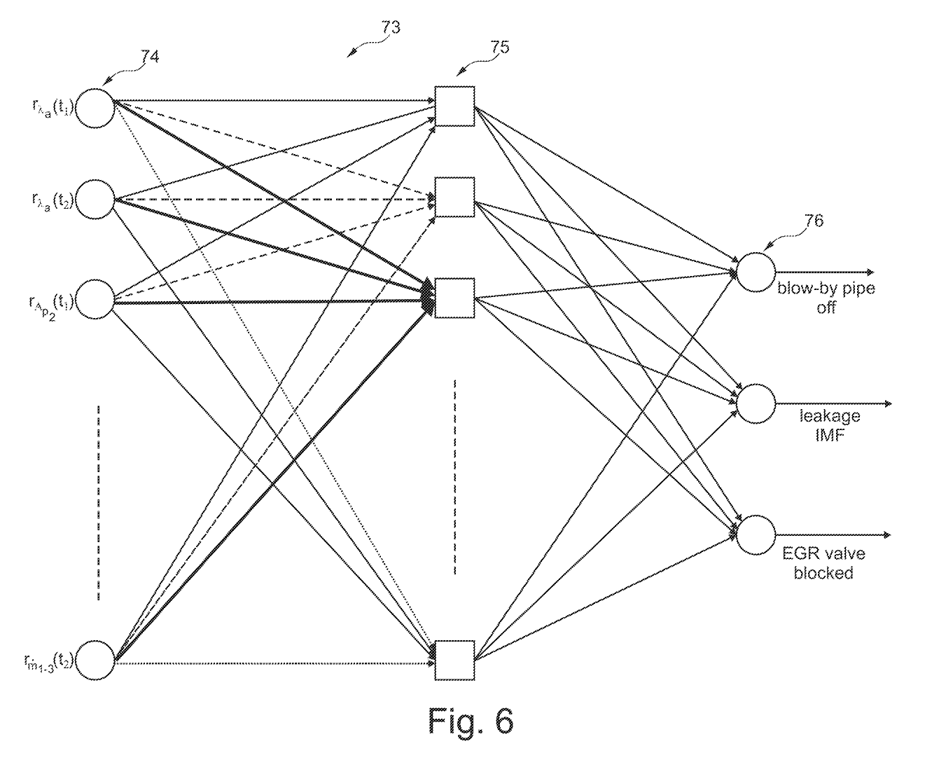

FIG. 6 shows a further embodiment of an evaluation unit in which the evaluation unit is designed as an ANN 73 of the multi-layer perceptron type. The ANN 73 is shown by way of example. Other classification methods, such as fuzzy logic systems or LLM models may be used. The ANN 73 comprises an input layer 74 of nodes, a processing layer 75 of nodes and an output layer 76 of nodes. Nodes which are not shown for simplicity in FIG. 6 are indicated by ellipsis dots. Residual values at two different sampling times t_1 and t_2 are provided to the nodes of the input layer 74. During operation of the ANN 37, the nodes of the processing layer 75 and the output layer 76 compute an output from a weighted average of their input values.

During a training of the ANN 73, values of residuals which are characteristic of certain error conditions are presented to the ANN 73 and weights of the weighted sums are adjusted such that the output values of the output layer nodes match the error condition. Here, by way of example, only the blow-by pipe, IMF leakage and EGR valve error conditions are shown. The ANN 73 may be extended to process residual values from more than just two sampling times or it may also process the current value of a residual only. Furthermore, the possible residual values may be partioned into intervals and the intervals may be assigned to different input nodes of the input layer 74. The ANN 73 may also comprise a further processing layer of nodes between the processing layer 75 and the output layer.

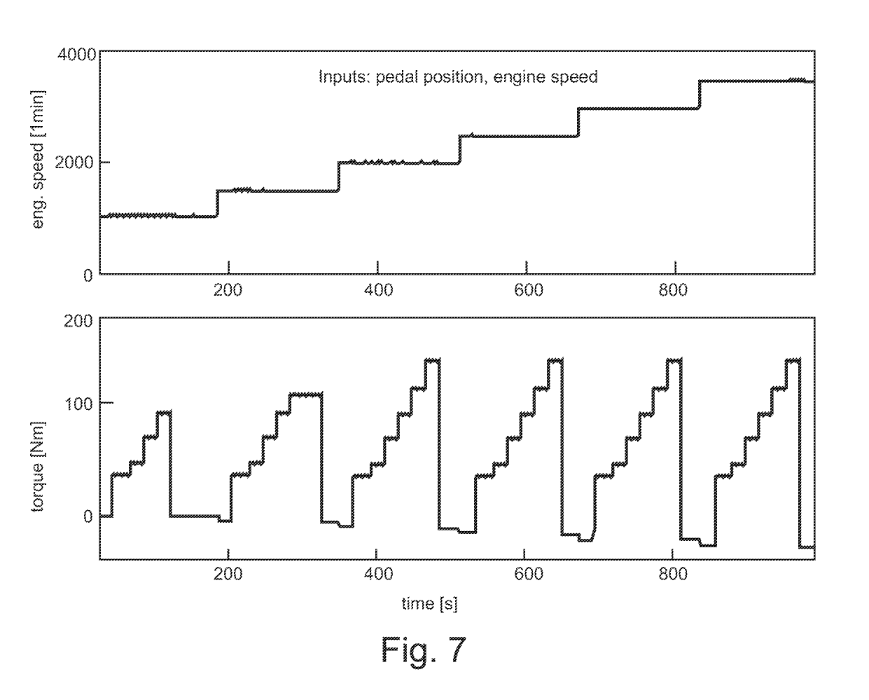

FIG. 7 illustrates, by way of example, engine speeds and motor torques that define operating points. The operating points are used during a training run of nominal model units. “BMEP” refers to the brake mean effective pressure. The operating point may be defined by other values than shown here, for example by engine revolution speed and fuel injection rate.

The operating points are indicated by a “+” sign in the following table:

| BMEP | Torque | Engine speed [rpm] | | | | | |
|---|---|---|---|---|---|---|---|
| [bar] | [Nm] | 1000 | 1500 | 2000 | 2500 | 3000 | 3500 |
| 1 | 15.1 | + | + | + | + | + | + |
| 2 | 30.2 | + | + | + | + | + | + |
| 4 | 60.5 | + | + | + | + | + | + |
| 6 | 90.7 | + | + | + | + | + | + |
| 8 | 121.0 | + | + | + | + | + | + |
| 10 | 151.2 | − | + | + | + | + | + |

During the training run, the motor speed and the BMEP are held constant for the time shown in the diagrams and corresponding values for the predicted quantities are determined, either by direct measurement or based on measurements by using model calculations. Parameters of the nominal models are adjusted such that the nominal models approximate the previously determined values at the operating points. The adjustment of the parameters is also referred to as a learning or calibration process of the nominal model. The operating points may be determined by other quantities than those shown in FIG. 7, for example by the injected fuel, by the opening of an EGR valve, or by a flap valve position.

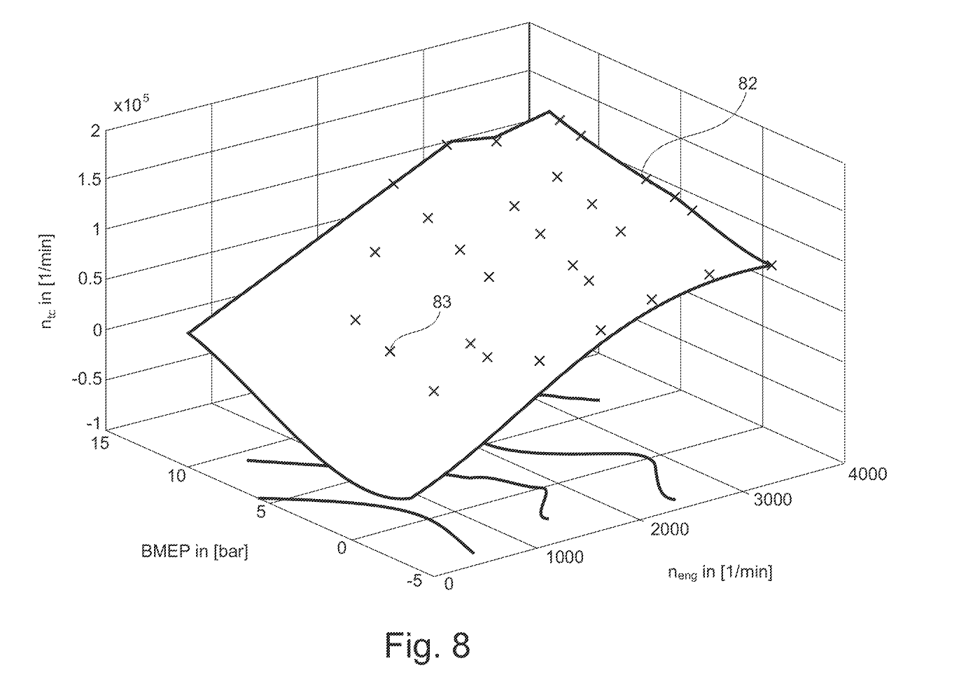

FIG. 8 shows, by way of example, a diagram for a nominal model. In FIG. 8, a turbocharger shaft speed n_tc is modeled as function of the operating point (n_eng, BMEP). The model is generated by a calibration procedure and may be stored in the form of a look-up table. In FIG. 8 the model output of the adjusted value for a given combination of BMEP and engine speed n_eng are indicated by a two dimensional surface 82. The two dimensional surface 82 may be realized as a lookup table in a computer readable memory. The determined values of n_tc at the operating point are indicated by crosses 83 which may lie above, on or below the surface 82. Level curves on the BMEP/engine speed plane illustrate the elevation profile of the two-dimensional plane. Similarly, nominal models for predicted values corresponding to the residuals of FIGS. 3 and 4 are determined by an approximation to values at predetermined operating points.

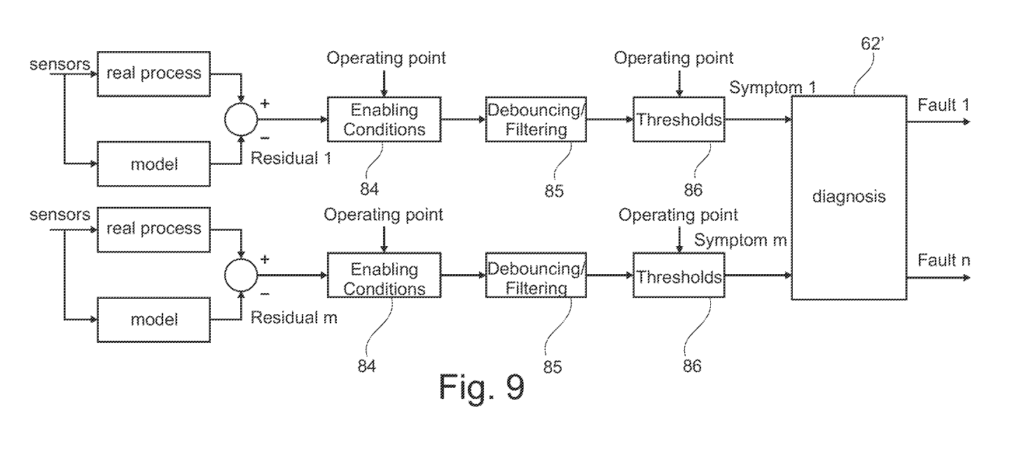

FIG. 9 shows a schematic flow diagram that further illustrates an evaluation of residuals according to the application. According to FIG. 9, m residuals are evaluated to generate n different fault conditions. In a residual generation step, the m residuals are generated by comparing output values from a model of the real process and from a nominal model. In a verification step, a verification unit 84 determines if an enabling condition is fulfilled, depending on an operating point. The operating point depends on input parameters of a nominal model, for example on the engine speed and on a fuel flow rate q_set. In a possible realization of the verification step, a residual is rejected as a valid input value for generating a fault condition if the flow rate q_set and the motor speed are not stable over a predetermined time or if the flow rate and the motor speed are not within a predetermined distance from an operating point.

In a compensation step, a compensation unit 85 smoothes out outliers and other irregularities by filtering and compensates for spikes resulting from the operation of electrical switches by debouncing. In an evaluation step, an evaluation unit 86 compares the output of the compensation unit against a high threshold and a low threshold, depending on the value of the input parameters of the nominal models and on the operating point, and generates a corresponding symptom signal. In a diagnosis step, a diagnosis unit 62′ evaluates the m symptom signals of the evaluation units to generate an error signal which indicates, which of the n faults have occurred. The diagnosis unit 62′ may use inference logic, fuzzy logic or other methods which may be realized by lookup tables, for example.

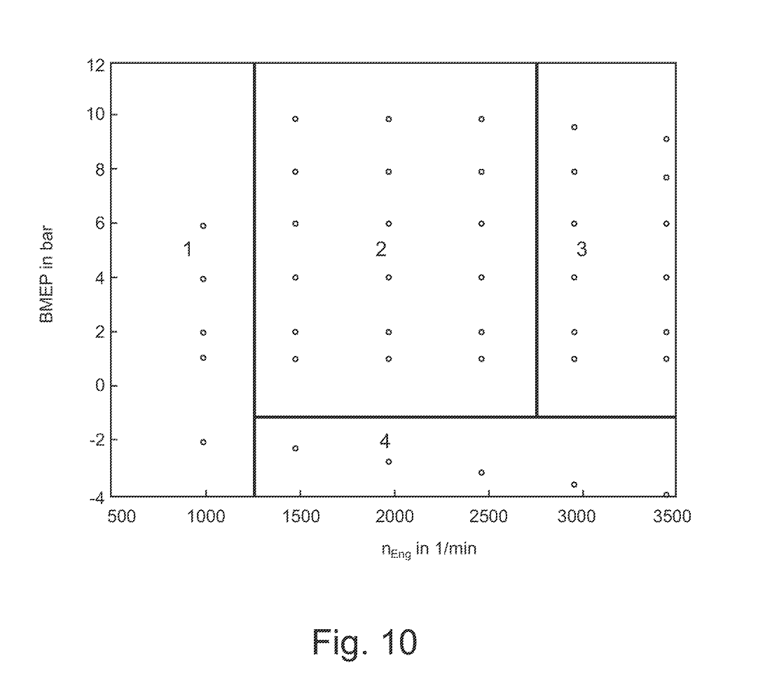

FIG. 10 shows, by way of example, a grouping of the parameter space of the input parameters of the nominal model into region according to the application. In this example, the parameter space is partitioned into 4 regions. To each of the four regions, a fault symptom table is associated. Operating points are indicated by circles. According to one embodiment of the application, a partitioning of the parameter space is defined through an iterative partitioning of parameter space using an LLM modeling procedure. Other classification methods, for example based on statistical methods, may also be used to partition the parameter space.

FIG. 11 illustrates a definition procedure for lower and upper thresholds of residuals. The upper left diagram shows a time behavior of a residual r_PC, relating to a compressor energy conversion rate. The compressor energy conversion rate is only used as an example here. A similar procedure also applies to the other residuals of this application but with different operating points. The time behavior of residuals at predefined operating points for known error conditions are used to define upper and lower thresholds, depending on the operating points. The diagrams on the right side show, respectively, lower and upper limits for r_PC depending on operating points. In this example, the operating points are defined by a grid on a two dimensional parameter space. The two dimensional parameter space is defined by a crankshaft revolution speed n_eng in revolutions per minute and a fuel throughput per cylinder, in cubic millimeters. A dead zone element, which is shown inside the square symbol, sets the residual signal to zero if it is within the lower and upper threshold. If the residual signal lies outside the thresholds, the residual signal is passed through.

FIG. 12 shows a generation of symptom values from residuals for the air flow efficiency λ_a. In FIG. 12, the upper flow diagram shows the generation of symptoms by comparing the sensor values at the measurement locations of FIG. 1 with the air flow model. The air flow model is shown in further detail in FIGS. 3 and 4. The lower flow diagram illustrates in further detail the symptom generation in case of the air flow efficiency λ_a.

The leftmost part of the diagram shows a comparison between process values of a physical model unit 95 and predicted model values of a nominal model unit 96 via the differentiator 90. The nominal model is also referred to as “semi-physical”. The process values may simply be sensor or command values or they can also be values that are derived from sensor or command values by using a physical model. The model values are generally derived from a nominal model that depends on an operating point, which may be defined through an engine speed n_eng and further input values such as the pressure p_2i, a flap valve command signal u_vsa, a boost density ρ_2i, the rate of injected fuel d/dt(m_f) or also the brake mean effective pressure. Thus, in general, the differentiator 90 subtracts output values of two different model computations, wherein the second model computation is at least dependent on an engine speed n_eng.

In the case of the air efficiency, the enabling conditions are realized via a condition evaluator 91 that checks if the EGR command value is below 0.6, indicating that the EGR valve is closed. A multiplier 92 is provided for fading out, and thus ignoring, the difference signal λ_a-λ_a,model depending on the opening status of the EGR valve. The debouncing and filtering unit 85 of FIG. 5 comprises a low pass filter 85 for filtering out signal oscillations. The output signal of the low pass filter 85 is passed on to the evaluation unit 86.

A dead zone element 99 of the evaluation unit 86 sets its output value to zero if its input value lies between a lower and an upper threshold. The lower and upper threshold are each determined a first lookup table 97 and a second lookup table 98. Threshold values that are stored in the lookup table are selected according to an operating point which is defined by the engine revolution speed n_eng and the fuel intake rate q_curr by using two dimensional lookup tables for the lower and the upper threshold. This can also be seen in FIG. 11. The fuel intake rate q_curr is filtered via a low pass filter 94 before it is used to select a threshold. After the output of the low pass 93, the residual signal is output for further use. The arrangement of FIG. 12 may also be realized without the low passes 93, 94.

The rows of the following table show error conditions, also referred to as system states, that correspond to the eight error conditions (1) to (8) shown in FIG. 2, which are labeled with F_1 to F_8 in the first column. The symbol “+” indicates a value above a positive threshold, the symbol “-” a value below of a negative threshold and “0” a value within a positive and a negative threshold. “I” indicates that the value does not contribute to identification of the error condition and is ignored and “/” stands for an “or” condition.

As mentioned in conjunction with FIG. 12, the thresholds may depend on an operating point of the diesel motor 11 and exceed a threshold may also depend on further criteria such as surpassing the limit for at least a minimum time. The header row lists eight fault symptoms, which correspond to: the air efficiency λ_a, the air mass flow amplitude, the charge pressure amplitude, the air mass flow 1-2, the air mass flow 1-3 and the air mass flow

| | Parameters | | | Air mass flows | | |
|---|---|---|---|---|---|---|
| F | S_λa | S_Am | S_Ap2 | S_m12 | S_m23 | S_m13 |
| F_1 | + | 0 | 0 | − | 0 | − |
| F_2 | − | 0 | 0 | + | 0 | + |
| F_3 | 0 | − | − | I | I | I |
| F_4 | +/− | +/− | +/− | I | I | I |
| F_5 | − | 0 | 0 | − | + | 0 |
| F_6 | I | I | I | 0 | 0 | 0 |
| F_7 | − | 0 | 0 | + | 0 | + |
| F_8 | + | 0 | 0 | − | 0 | − |

FIG. 13 shows in more detail the residual generation unit of FIG. 3, FIG. 4. In particular, FIG. 14 shows the sub models of the physical modeling unit 40 and the structure of the mass flow computation, which is shown in FIG. 13 in a simplified manner Physical airflow modeling units 40 are provided for generating a first set of predicted values λ_a, A_p2, A_m_air from a first set of measurement values. Furthermore, nominal modeling units 42, 43, 44, are provided for computing second predicted values from a second set of measurement values.

The modeling units 41, 45 for the air mass flow can be regarded as nominal modeling units. Differentiators are provided to subtract second predicted values from first predicted values. First and second predicted values for the mass flows d/dt(m_air,1); d/dt(m_air,2), d/dt(m_air,3) are subtracted in all possible combinations. The resulting residuals r_m_12, r_m_13, r_m_23 can be represented as differences of a physical model term and a nominal model term.

The output of the physical model is generally more sensitive to error conditions than the output of the nominal model. The difference in the mode units 40, 41 is also reflected in the input values, wherein the second set of measurement values corresponding to the nominal model unit 41 generally have a larger proportion of externally controllable quantities, such as fuel flow or ECU control signals, than the first set of measurement values. Secondly the difference of the model units is also reflected in that the nominal model unit relies more on the use of semi empirical models such as pre-calibrated lookup tables than on algebraically relationships. Due to the different behavior of the modeling units, errors can be detected by comparing the output values of the modeling units.

Although the above description contains many specific details, these should not be construed as limiting the scope of the embodiments but merely providing illustration of the foreseeable embodiments. Especially, the above stated advantages of the embodiments should not be construed as limiting the scope of the embodiments but merely to explain possible achievements if the described embodiments are put into practice. These considerations also apply to the technical realization of the modeling units which may for example be realized as instructions of a computer readable program which in turn may be hardwired or stored in a computer readable memory, for example as instructions burned into an EPROM. Further realizations include lookup tables and interpolation of such lookup tables and hardwired embodiments of empirical models such as local linear model trees (also known as LOLIMOT or LLM), neuronal networks and the like. The modeling units may correspond to hardware units but also to program modules or functions. Furthermore, in other embodiments one program module or hardware module may also correspond to several modeling units and vice versa.

The application applies especially to a four cylinder common rail diesel engine that is equipped with a VGT turbocharger and a high pressure exhaust gas recirculation which may also comprise a low pressure exhaust gas recirculation. But the range of application is more general. For example other numbers of cylinders, and various designs of EGR cycles are possible. Various aspects of the application also apply to other types of internal combustion engines with exhaust gas recirculation and do not necessarily require a turbocharger or a common rail system.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A combustion engine evaluation unit, comprising:
a microcontroller configured to receive measurement signals from a gas flow control system of a combustion engine and also configured to produce a state signal indicating a state of the gas flow control system;
first input ports for the microcontroller, the first input ports configured to receive at least measurement signals as a first set of measurement signals, the first set of measurement signals, and the first set of measurement signals comprising:
an intake pressure downstream of a high pressure exhaust gas recirculation valve;
an intake temperature downstream of the high pressure exhaust gas recirculation valve; and
an intake air flow rate downstream of an air filter,
second input ports for the microcontroller, the second input ports configured to receive a second set of measurement signals, the second set of measurement signals comprising:
a motor revolution speed; and
a flap valve position signal,
wherein the microcontroller is furthermore configured to:
calculate a first set of predicted values by using a gas flow model based on the first set of measurement signals;
calculate a second set of predicted values by using a nominal model based on the second set of measurement signals; and
generate the state signal based on a comparison of the first set of predicted values with the second set of predicted values.

2. The combustion engine evaluation unit according to claim 1, further comprising a residual generation unit with differentiators configured to compare the first set of predicted values and the second set of predicted values, and
wherein the differentiators are configured to generate residuals by subtracting values of the second set of predicted values from corresponding values of the second set of predicted values with the differentiators.

3. The combustion engine evaluation unit according to claim 2, wherein the residual generation unit is configured to generate an air efficiency residual from the first set of measurement signals and the second set of measurement signals.

4. The combustion engine evaluation unit according to claim 3,
wherein the air efficiency residual is based on a difference of a first predicted air efficiency from the first set of predicted values and a second predicted air efficiency from the second set of predicted values, and
wherein the second predicted air efficiency is based on a lookup table value that depends on an engine speed, the intake pressure, and a flap valve control signal.

5. The combustion engine evaluation unit according to claim 2, wherein the residual generation unit is configured to generate an air flow oscillation amplitude residual that forms the first set of measurement signals and the second set of measurement signals.

6. The combustion engine evaluation unit according to claim 5,
wherein the second set of measurement signals comprises an EGR valve position,
wherein the air flow oscillation amplitude residual is based on a difference of a first predicted air flow oscillation amplitude from the first set of predicted values and a second predicted air flow oscillation amplitude from the second set of predicted values, and
wherein the second predicted air flow oscillation amplitude is based on a lookup table value that depends on an engine speed, the intake pressure, the intake temperature, and the EGR valve position.

7. The combustion engine evaluation unit according to claim 2, wherein the residual generation unit is configured to generate a pressure oscillation amplitude residual from the first set of measurement signals and the second set of measurement signals.

8. The combustion engine evaluation unit according to claim 7,
wherein the second set of measurement signals comprise an EGR valve position,
wherein the pressure oscillation amplitude residual is based on a difference of a first predicted pressure oscillation amplitude from the first set of predicted values and a second predicted pressure oscillation amplitude from the second set of predicted values, and
wherein the second predicted pressure oscillation amplitude is based on a lookup table value that depends on an engine speed, the intake pressure, the intake temperature and the EGR valve position.

9. The combustion engine evaluation unit according to claim 2, wherein the first set of measurement signals further comprises an exhaust pressure upstream of an EGR valve and an EGR valve temperature and wherein the residual generation unit that is configured to generate at least one gas flow residual from the first set of measurement signals and the second set of measurement signals.

10. The combustion engine evaluation unit according to claim 9,
wherein the at least one gas flow residual is based on a difference of a first predicted mass flow from the first set of predicted values and a second predicted mass flow from the second set of predicted values, and
wherein the second predicted mass flow is based on a lookup table value that depends on an engine speed, a pressure downstream of an EGR recirculation valve, and a command signal of a flap valve.

11. The combustion engine evaluation unit according to claim 9,
wherein the at least one gas flow residual is based on a difference of a first predicted mass flow from the first set of predicted values and a second predicted mass flow from the second set of predicted values, and
wherein the second predicted mass flow is based on an engine speed, a measurement value from a lambda sensor and a volume of injected fuel.

12. An engine control unit, comprising:
input ports
a combustion engine evaluation unit, the combustion engine evaluation unit, comprising:
a microcontroller configured to receive measurement signals from a gas flow control system of a combustion engine and also configured to produce a state signal indicating a state of the gas flow control system;
first input ports for the microcontroller, the input ports configured to receive at least measurement signals as a first set of measurement signals, the first set of measurement signals, the first set of measurement signals comprising:
an intake pressure downstream of a high pressure exhaust gas recirculation valve;
an intake temperature downstream of the high pressure exhaust gas recirculation valve; and
an intake air flow rate downstream of an air filter,
second input ports for the microcontroller, the second input ports configured to receive a second set of measurement signals, the second set of measurement signals comprising:
a motor revolution speed; and
a flap valve position signal,
wherein the microcontroller is furthermore configured to:
calculate a first set of predicted values by using a gas flow model based on the first set of measurement signals;
calculate a second set of predicted values by using a nominal model based on the second set of measurement signals; and
generate the state signal based on a comparison of the first set of predicted values with the second set of predicted values;
engine control input ports connected to the input ports of the combustion engine evaluation unit; and
engine control output ports connected to output ports of the combustion engine evaluation unit.

13. The engine control unit according to claim 12, further comprising a residual generation unit with differentiators configured to compare the first set of predicted values and the second set of predicted values, and
wherein the differentiators are configured to generate residuals by subtracting values of the second set of predicted values from corresponding values of the second set of predicted values with the differentiators.

14. The engine control unit according to claim 13, wherein the residual generation unit is configured to generate an air efficiency residual from the first set of measurement signals and the second set of measurement signals.

15. The engine control unit according to claim 14,
wherein the air efficiency residual is based on a difference of a first predicted air efficiency from the first set of predicted values and a second predicted air efficiency from the second set of predicted values, and
wherein the second predicted air efficiency is based on a lookup table value that depends on an engine speed, the intake pressure, and a flap valve control signal.

16. The engine control unit according to claim 13, wherein the residual generation unit is configured to generate an air flow oscillation amplitude residual that forms the first set of measurement signals and the second set of measurement signals.

17. The engine control unit according to claim 16,
wherein the second set of measurement signals comprises an EGR valve position,
wherein the air flow oscillation amplitude residual is based on a difference of a first predicted air flow oscillation amplitude from the first set of predicted values and a second predicted air flow oscillation amplitude from the second set of predicted values, and
wherein the second predicted air flow oscillation amplitude is based on a lookup table value that depends on an engine speed, the intake pressure, the intake temperature, and the EGR valve position.

18. The engine control unit according to claim 13, wherein the residual generation unit is configured to generate a pressure oscillation amplitude residual from the first set of measurement signals and the second set of measurement signals.

19. The engine control unit according to claim 18,
wherein the second set of measurement signals comprise an EGR valve position,
wherein the pressure oscillation amplitude residual is based on a difference of a first predicted pressure oscillation amplitude from the first set of predicted values and a second predicted pressure oscillation amplitude from the second set of predicted values, and
wherein the second predicted pressure oscillation amplitude is based on a lookup table value that depends on an engine speed, the intake pressure, the intake temperature and the EGR valve position.

20. The engine control unit according to claim 13, wherein the first set of measurement signals further comprises an exhaust pressure upstream of an EGR valve and an EGR valve temperature and wherein the residual generation unit that is configured to generate at least one gas flow residual from the first set of measurement signals and the second set of measurement signals.
